(19) United States
(12) Patent Application Publication
(10) Pub. No.: US 2023/0371734 A1
(43) Pub. Date: Nov. 23, 2023

(54) MANUAL COFFEE MACHINE

(71) Applicant: ZHEJIANG WUYI WJL PLASTIC INDUSTRY CO. LTD, Wuyi (CN)

(72) Inventor: JIANMIN WANG, YONGKANG (CN)

(21) Appl. No.: 17/846,279

(22) Filed: Jun. 22, 2022

(30) Foreign Application Priority Data
May 23, 2022 (CN) 202221249952.3

(51) Int. Cl. A47J 31/38; A47J 31/44; A47J 31/46

(52) U.S. Cl. CPC A47J 31/38; A47J 31/4407; A47J 31/461

(57) ABSTRACT

The utility model relates to the technical field of coffee machines, and discloses a manual coffee machine, comprising a liner, a coffee cup, a piston assembly and a driving rod. The driving rod is connected with the piston assembly and drives the piston assembly to rise and fall in the liner; the piston assembly separates an inner cavity of the liner into an upper cavity body and a lower cavity body; the piston assembly comprises a piston, a bracket and a valve core; the piston is provided with a water hole; and the valve core is limited and installed between the bracket and the water hole through the bracket. When the piston assembly rises and falls, the valve core unblocks or blocks the water hole. A pressure relief channel is arranged in the valve core; a port which communicates the pressure relief channel and the lower cavity body is a pressure relief port; a spring and a sealing body are installed in the pressure relief channel; and the spring is pressed against the sealing body on the pressure relief port. On the one hand, the valve core acts as a water valve switch; and on the other hand, the valve core can achieve the effect of decompression and protection. After water pressure exceeds a certain value, the pressure relief channel of the valve core is turned on to avoid an explosion accident caused by excessive water pressure in the lower cavity body; and the safety of the coffee machine is higher.

### TECHNICAL FIELD

The utility model relates to the technical field of coffee machines, and in particular to a manual coffee machine.

### BACKGROUND

The manual coffee machine is convenient for people to carry, so that coffee lovers can drink coffee anytime and anywhere. For example, in the manual coffee machine with application No. 202122426576.2, hot water is injected into a cylinder body from a water injection cover; a rocker screw rotates to open a water valve switch; and the rocker screw is continuously rotated to drive a cylinder piston to move upward, so that the hot water flows between the cylinder piston and a water splitter. In work, the rocker screw is reversely rotated to close the water valve switch, and at the same time, the cylinder piston is driven to press the hot water so that the hot water is pressed into a coffee powder bowl and mixed with coffee powder. When the cylinder piston presses the hot water, water pressure is too large, which easily causes explosion. At the same time, the existing coffee machine has relatively single function, and can only use coffee powder or coffee capsule, so that versatility is poor. In addition, a coffee cup and the coffee machine are independent and cannot be assembled together. In this way, on the one hand, it is not convenient to carry the coffee cup and the coffee machine. On the other hand, the coffee cup and an outlet of the coffee machine are complicated in health protection, and easy to be polluted by the outside world.

### SUMMARY

In view of the defects in the prior art, the utility model provides a manual coffee machine.

To solve the above technical problems, the utility model adopts the following technical solution:

A manual coffee machine comprises a liner, a coffee cup, a piston assembly and a driving rod. The driving rod is connected with the piston assembly and drives the piston assembly to rise and fall in the liner; the piston assembly separates an inner cavity of the liner into an upper cavity body and a lower cavity body; the piston assembly comprises a piston, a bracket and a valve core; the piston is provided with a water hole through which water flows from the upper cavity body into the lower cavity body; and the valve core is limited and installed between the bracket and the water hole through the bracket. When the piston assembly rises and falls, the valve core unblocks or blocks the water hole. A pressure relief channel for communicating the upper cavity body and the lower cavity body is arranged in the valve core; a port which communicates the pressure relief channel and the lower cavity body is a pressure relief port; a spring and a sealing body are installed in the pressure relief channel; and the spring is pressed against the sealing body on the pressure relief port. On the one hand, the valve core acts as a water valve switch. When the piston rises, hot water in the upper cavity body can flow into the lower cavity body. On the other hand, the valve core can achieve the effect of decompression and protection. When the piston falls, the water hole is closed and the piston presses the hot water in the lower cavity body into a next component. After water pressure exceeds a certain value, the pressure relief channel of the valve core is turned on to conduct pressure relief processing on the lower cavity body, to avoid an explosion accident caused by excessive water pressure in the lower cavity body; and the safety of the coffee machine is higher.

Preferably, the water hole is funnel-shaped; a sealing ring is sleeved on the lower end of the valve core; and when the water hole is partitioned, the sealing ring is hermetically connected with a conical surface of the water hole. Due to the funnel-shaped water hole, on the one hand, the flow of the hot water is facilitated, and on the other hand, the sealing ring of the valve core and the side wall of the water hole have good sealing performance during sealing.

Preferably, the bracket is an integral bracket; the bracket comprises a limiting segment and supporting segments; a projection shape of the limiting segment is annular; the driving rod is firmly connected with the valve core through the limiting segment; at least two supporting segments are uniformly distributed around the limiting segment; pistons at lower ends of the supporting segments are firmly connected; and when the water hole is partitioned, a gap is arranged between a top end of the valve core and the limiting segment. The bracket is used to limit the valve core. When the driving rod drives the valve core to rise and fall, the piston can also be driven by the bracket to move up and down.

Preferably, the valve core comprises a valve core body and a valve core cover; the valve core cover is in threaded connection with the valve core body; the valve core cover is connected with the driving rod by screws; the pressure relief channel comprises a spring cavity and a pressure relief hole; the spring cavity is arranged between the valve core body and the valve core cover; the spring is installed in the spring cavity; the pressure relief hole is arranged in a side wall of the valve core body; the pressure relief hole is communicated with the upper cavity body and the spring cavity; a lower end of the spring cavity is funnel-shaped; the sealing body is a sealing sphere; and the sealing body is limited on a conical surface of the spring cavity. The split valve core is convenient for installation of the spring and the sealing body. At the same time, the valve core cover is detachably installed on the driving rod by screws, so that the piston assembly can be removed and cleaned.

Preferably, a lower end of the liner is provided with a first joint; the first joint is detachably provided with a positioning cup; a bottom of the positioning cup is provided with a funnel-shaped coffee outlet; a powder bin box is installed in the positioning cup; the coffee cup is installed at an outer side of the positioning cup; a powder bin cover arranged below the water hole is installed at a top end of the powder bin box; the powder bin cover is provided with a plurality of water diversion holes communicated with the powder bin box; and a silicone flat valve for extruding coffee liquid is installed at a bottom of the powder bin box. The first joint is convenient to install the positioning cup. The positioning cup is used for installing the powder bin box on the one hand and used for storing or positioning the coffee cup on the other hand. A slotted gap is arranged at an outlet of the silicone flat valve at the bottom of the powder bin box. The gap automatically expands after reaching certain pressure through the elasticity of silica gel to extract coffee oil.

Preferably, a filter screen is installed at the bottom of the powder bin box; the bottom of the powder bin box is provided with a stepped hole; the silicone flat valve is installed on the powder bin box through the stepped hole; and the filter screen is arranged above the silicone flat valve. The stepped hole is convenient for installing the silicone flat valve; and the filter screen is arranged above the silicone flat valve for blocking large-particle coffee powder, so as to ensure the mouth feel of extracted coffee.

Preferably, a second joint which extends down is arranged at the edge of the lower end surface of the powder bin cover; the second joint is positioned between the positioning cup and the powder bin box; and the upper end part of the powder bin box is hermetically connected with the second joint through the sealing ring. On the one hand, the first joint ensures the stability of the powder bin cover, and on the other hand, the first joint is hermetically connected with the powder bin box to provide enough contact surface, to ensure that the hot water is fully pressed into the powder bin box.

Preferably, the lower end of the liner is provided with a first joint; the first joint is detachably provided with a positioning cup; a capsule box for placing capsules is installed in the positioning cup; the coffee cup is installed at the outer side of the positioning cup; the bottom of the positioning cup is provided with a capsule bottom cover net; a plurality of bumps and through holes are arrayed on the capsule bottom cover net; the capsule box is inverted on the capsule bottom cover net; the top of the capsule box is provided with a water through hole communicated with the water hole; and a blade for piercing a capsule is installed at the top of the inner cavity of the capsule box near the water through hole. The first joint can be connected with the powder bin box, and can also be connected with the capsule box, so that the coffee machine has strong versatility.

Preferably, the coffee cup is clamped and connected with the first joint; a plurality of positioning parts are uniformly distributed on the outer side wall of the upper end of the first joint; a plurality of clamping parts are uniformly distributed on an inner wall of the coffee cup near a cup opening; and the clamping parts of the coffee cup are clamped, positioned and connected with the positioning parts of the positioning cup. The coffee cup can be stored on the first joint. On the one hand, it is convenient to carry the integral coffee machine and coffee cup, and on the other hand, the coffee cup and the outlet of the coffee machine form a closed space, which effectively prevents the outlet of the coffee machine and the coffee cup from being polluted.

Preferably, each positioning part comprises a first positioning block, a second positioning block and a clamping block; the first positioning block and the second positioning block are arranged in parallel; a positioning slot is formed between the first positioning block and the second positioning block; the clamping block is installed in the positioning slot; each clamping part is a third positioning block; the third positioning block is provided with a clamping slot; and when the coffee cup is clamped and connected with the positioning cup, the clamping part is limited in the positioning slot, and the clamping block is clamped in the clamping slot. The clamping part on the coffee cup is limited in the positioning slot of the positioning part, and the clamping slot on the clamping part is also clamped and connected with the clamping block, so that the coffee cup has high stability on the first joint.

Preferably, a plurality of positioning parts are also arranged on the outer side wall of the lower end of the positioning cup; and when coffee is made through the coffee cup, the coffee cup is clamped and connected with the positioning parts at the lower end of the positioning cup. When people need to make coffee, only the coffee cup is clamped on the positioning parts on the positioning cup, which is convenient to operate.

Preferably, the top end of the liner is provided with a water injection cover; a water injection hole communicated with the upper cavity body is arranged on the water injection cover; a screw rod-screw thread adapter is arranged in the middle of the water injection cover; the driving rod is a screw rod; the screw rod extends from the water injection cover through the screw rod-screw thread adapter; and the top end of the driving rod is provided with a telescopic handle. When the coffee machine is not used, the telescopic handle can be retracted onto the coffee machine, which is convenient for people to carry and store the coffee machine.

The utility model has remarkable technical effects because the above technical solution is adopted:

On the one hand, the valve core acts as a water valve switch. When the piston rises, hot water in the upper cavity body can flow into the lower cavity body. On the other hand, the valve core can achieve the effect of decompression and protection. When the piston falls, the water hole is closed and the piston presses the hot water in the lower cavity body into a next component. After water pressure exceeds a certain value, the pressure relief channel of the valve core is turned on to avoid an explosion accident caused by excessive water pressure in the lower cavity body; and the safety of the coffee machine is higher. The first joint on the coffee machine can be connected with the powder bin box, and can also be connected with the capsule box, so that the coffee machine has strong versatility. When the coffee machine is not used, the telescopic handle can be retracted onto the coffee machine, which is convenient for people to carry and store the coffee machine.

### DESCRIPTION OF DRAWINGS

FIG. 1 is an internal structural schematic diagram of a liner and a coffee cup after sectioning in the utility model.

FIG. 2 is a structural schematic diagram without the liner and the coffee cup in FIG. 1.

FIG. 3 is a non-sectional structural schematic diagram in FIG. 2.

FIG. 4 is a structural schematic diagram of a liner in FIG. 1.

FIG. 5 is a structural schematic diagram of a coffee cup in FIG. 1.

FIG. 6 is a structural schematic diagram of a powder bin cover in FIG. 2.

FIG. 7 is a structural schematic diagram of a capsule box in the utility model.

FIG. 8 is a structural schematic diagram of FIG. 7 in another position state.

FIG. 9 is a structural schematic diagram of a capsule bottom cover net in FIG. 2.

Component names referred to by the numbers in the above drawings are as follows:
wherein 10—liner; 11—coffee cup; 12—piston assembly; 13—driving rod; 14—positioning cup; 15—powder bin box; 16—powder bin cover; 17—silicone flat valve; 18—filter screen; 19—capsule box; 20—capsule bottom cover net; 21—positioning part; 22—water injection cover; 23—screw rod-screw thread adapter; 24—handle; 101—upper cavity body; 102—first joint; 111—clamping part; 112—clamping slot; 120—gap; 121—piston; 122—bracket; 123—valve core; 124—sealing ring; 141—coffee outlet; 151—stepped hole; 161—water diversion hole; 162—second joint; 191—water through hole; 192—blade; 201—bump; 202—through hole; 210—positioning slot; 211—first positioning block; 212—second positioning block; 213—clamping block; 221—water injection hole; 241—telescopic tube; 242—telescopic rod; 243—handle sleeve; 1211—water hole; 1221—limiting segment; 1222—supporting segment; 1230—pressure relief channel; 1231—valve core body; 1232—valve core cover; 1233—spring; 1234—sealing body; 12301—pressure relief port; 12302—spring cavity; 12303—pressure relief hole.

### DETAILED DESCRIPTION

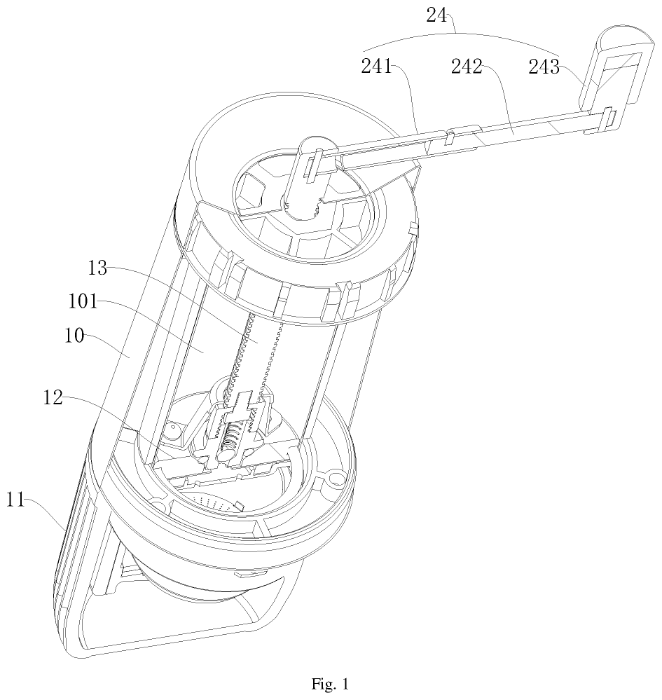

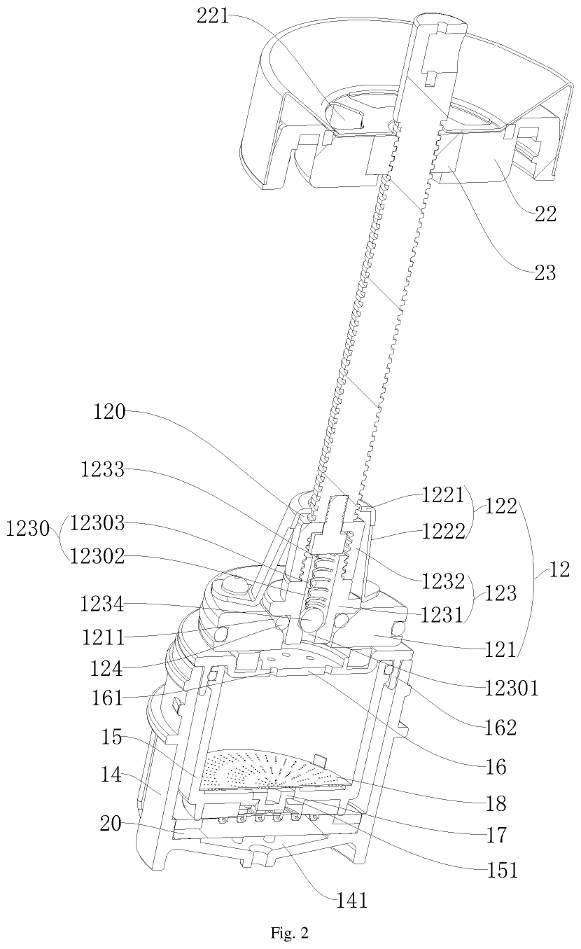

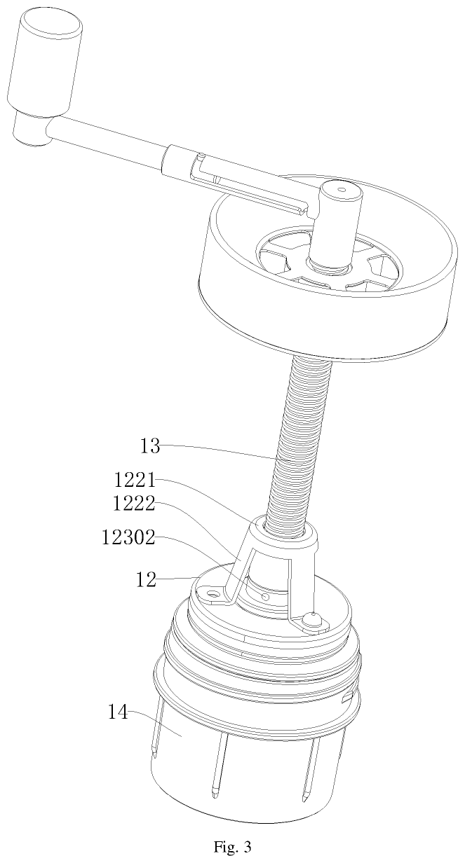

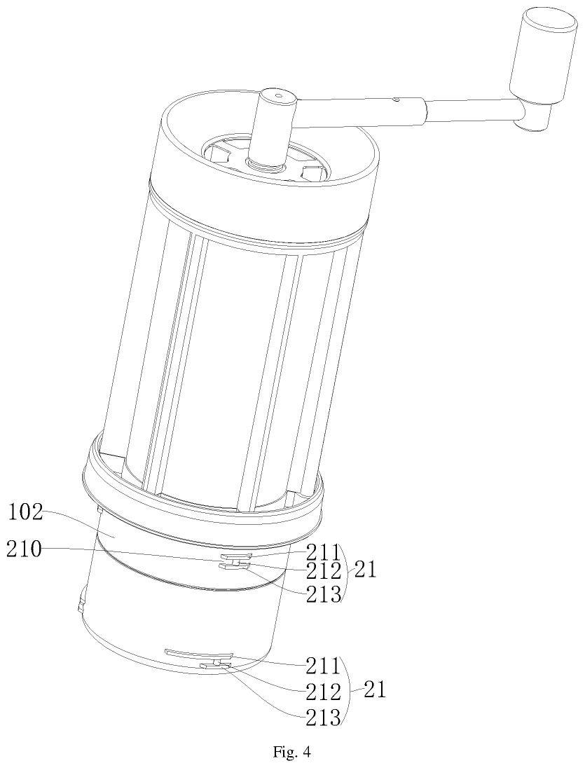

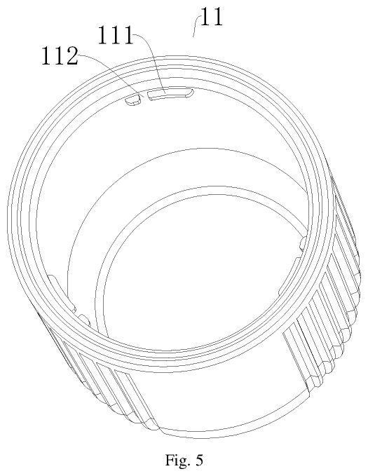

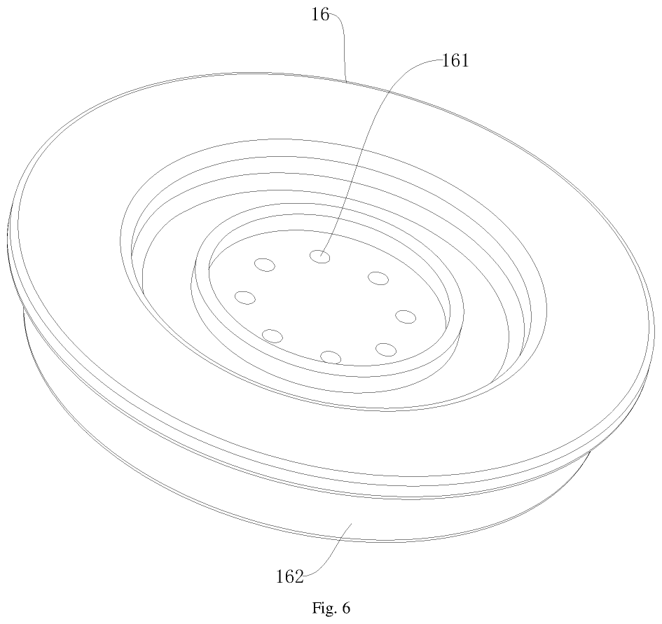

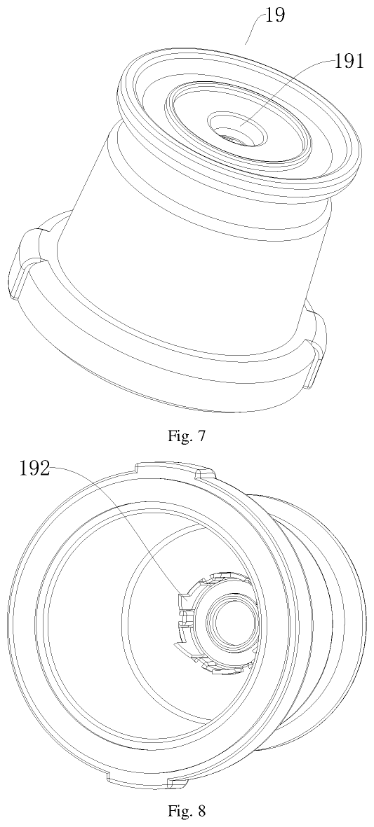

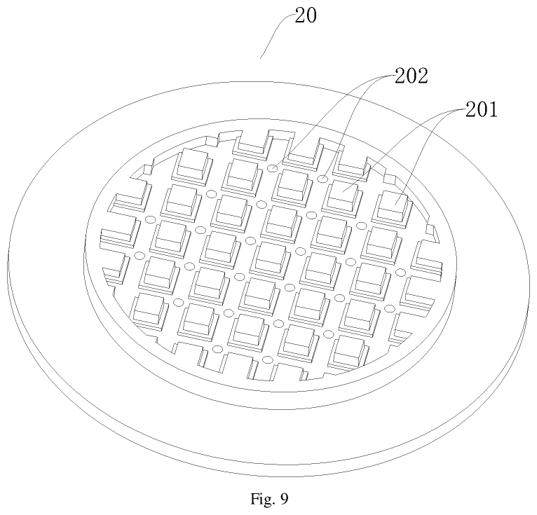

The utility model is further described below in detail in combination with FIGS. 1-9 and embodiments.

### Embodiment 1

A manual coffee machine comprises a liner 10, a coffee cup 11, a piston assembly 12 and a driving rod 13; and the driving rod 13 is connected with the piston assembly 12 and drives the piston assembly to rise and fall in the liner 10. In the present embodiment, the driving rod 13 is a screw rod, and the driving rod 13 rotates to drive the piston assembly 12 to rise and fall in the liner 10. The piston assembly 12 separates an inner cavity of the liner 10 into an upper cavity body 101 and a lower cavity body. When the driving rod 13 drives the piston assembly 12 to rise, a boiled water valve on the piston assembly 12 is turned on, and hot water in the upper cavity body 101 flows through the piston assembly 12 to flow into the lower cavity body. When the driving rod 13 is operated reversely, the piston assembly 12 falls; the boiled water valve on the piston assembly 12 is turned off; and the piston assembly 12 presses the hot water in the lower cavity body into the powder bin box 15 or the capsule box 19. The piston assembly 12 comprises a piston 121, a bracket 122 and a valve core 123; the piston 121 is provided with a water hole 1211 through which water flows from the upper cavity body 101 into the lower cavity body; the valve core 123 is limited and installed between the bracket 122 and the water hole 1211 through the bracket 122; when the piston assembly 12 rises and falls, the valve core 123 unblocks or blocks the water hole 1211; and the valve core 123 and the water hole 1211 form the boiled water valve. A pressure relief channel 1230 for communicating the upper cavity body 101 and the lower cavity body is arranged in the valve core 123; a port which communicates the pressure relief channel 1230 and the lower cavity body is a pressure relief port 12301; a spring 1233 and a sealing body 1234 are installed in the pressure relief channel 1230; and the spring 1233 is pressed against the sealing body 1234 on the pressure relief port 12301. Because boiled water is added into the liner 10 and water temperature is high, when the hot water in the lower cavity body is pressed down, water pressure is too high and high-temperature hot water is easy to spray out of a gap. The valve core 123 integrates a pressure relief function. When water pressure is too high, the hot water will open the sealing body 1234, so that water vapor is discharged into the upper cavity body 101 through the pressure relief channel 1230, to ensure the safety of the coffee machine.

The water hole 1211 is funnel-shaped, and the funnel-shaped water hole 1211 makes the hot water in the upper cavity body 101 flow into the lower cavity body smoothly. The forward projection shape of the valve core 123 is “crossed”; a sealing ring 124 is sleeved on the lower end of the valve core 123; and when the water hole 1211 is partitioned, the sealing ring 124 is hermetically connected with a conical surface of the water hole 1211. The sealing ring 124 at the lower end of the valve core 123 and the water hole 1211 have strong sealing performance to prevent the hot water in the lower cavity body from flowing back into the upper cavity body 101.

The bracket 122 is an integral bracket; the bracket 122 comprises a limiting segment 1221 and supporting segments 1222; a projection shape of the limiting segment 1221 is annular; the driving rod 13 is firmly connected with the valve core 123 through the limiting segment 1221; and the driving rod 13 is not in contact with the limiting segment 1221 to ensure that the driving rod 13 can pull the valve core 123 up and down. At least two supporting segments 1222 are uniformly distributed around the limiting segment 1221. In the present embodiment, the number of the supporting segments 1222 is three. The supporting segments 1222 are equivalent to supporting feet of the bracket 122; and pistons 121 at lower ends of the supporting segments 1222 are firmly connected. The limiting segment 1221 is equivalent to a limiting ring to block the valve core 123 from moving up. At the same time, when the driving rod 13 rotates, the valve core 123 can drive the limiting segment 1221 to rise together, so as to drive the pistons 121 to rise. When the water hole 1211 is partitioned, a gap 120 is arranged between a top end of the valve core 123 and the limiting segment 1221. The gap 120 is used to allow the valve core 123 to open the water hole 1211, so that the water in the upper cavity body 101 can flow into the lower cavity body.

The valve core 123 comprises a valve core body 1231 and a valve core cover 1232; the valve core cover 1232 is in threaded connection with the valve core body 1231; and the valve core cover 1232 is connected with the driving rod 13 by screws. The split valve core 123 is used for processing the spring cavity 12302 in the valve core body 1231 on the one hand, and is used for detachably installing the valve core cover 1232 on the driving rod 13 on the other hand, so that the piston assembly 12 can be entirely removed and cleaned. The pressure relief channel 1230 comprises a spring cavity 12302 and a pressure relief hole 12303; the spring cavity 12302 is arranged between the valve core body 1231 and the valve core cover 1232; the spring 1233 is installed in the spring cavity 12302; the pressure relief hole 12303 is arranged in a side wall of the valve core body 1231; the pressure relief hole 12303 is communicated with the upper cavity body 101 and the spring cavity 12302; a lower end of the spring cavity 12302 is funnel-shaped; the sealing body 1234 is a sealing sphere; and the sealing body 1234 is pressed by the spring 1233 and limited on a conical surface of the spring cavity 12302.

The lower end of the liner 10 is provided with a first joint 102. In the present embodiment, the first joint 102 and the liner 10 are integral; the first joint 102 is detachably provided with a positioning cup 14; an inner wall of the first joint 102 is provided with an internal thread; the positioning cup 14 is provided with an external thread; and the positioning cup 14 is in threaded connection with the first joint 102. A bottom of the positioning cup 14 is provided with a funnel-shaped coffee outlet 141; a powder bin box 15 for storing coffee powder is installed in the positioning cup 14; the coffee cup 11 is detachably installed at an outer side of the positioning cup 14; a powder bin cover 16 arranged below the water hole 1211 is installed at a top end of the powder bin box 15; the powder bin cover 16 is provided with a plurality of water diversion holes 161 communicated with the powder bin box 15; and a silicone flat valve 17 for extruding coffee liquid is installed at a bottom of the powder bin box 15.

A filter screen 18 is installed at the bottom of the powder bin box 15; the bottom of the powder bin box 15 is provided with a stepped hole 151; the silicone flat valve 17 is installed on the powder bin box 15 through the stepped hole 151; and the filter screen 18 is arranged above the silicone flat valve 17. A slotted gap is arranged at an outlet of the silicone flat valve 17 at the bottom of the powder bin box 15. The gap automatically expands after reaching certain pressure through the elasticity of silica gel to extract coffee oil, so as to improve the mouth feel of coffee.

A second joint 162 which extends down is arranged at the edge of the lower end surface of the powder bin cover 16; the second joint 162 and the powder bin cover 16 are formed by integral molding; the second joint 162 is positioned and installed between the positioning cup 14 and the powder bin box 15; the stability of the powder bin cover 16 is high; and the upper end part of the powder bin box 15 is hermetically connected with the second joint 162 through the sealing ring to ensure that the coffee liquid in the powder bin box 15 may not overflow.

The top end of the liner 10 is provided with a water injection cover 22; hot water can be injected into the liner 10 through the water injection cover 22; water injection cover 22 is provided with a water injection hole 221 communicated with the upper cavity body 101; the middle of the water injection cover 22 is provided with a screw rod-screw thread adapter 23; the driving rod 13 is a screw rod; the screw rod extends out of the water injection cover through the screw rod-screw thread adapter 23; and the top end of the driving rod 13 is provided with a telescopic handle 24. The telescopic handle 24 in the present embodiment comprises a telescopic tube 241, a telescopic rod 242 and a handle sleeve 243; the telescopic tube 241 is vertically installed at the top of the driving rod 13 through a pin shaft; the telescopic rod 242 is installed in the telescopic tube 241 in a mode of expansion and contraction; the telescopic tube 241 is provided with a limiting pin; and a limiting hole is arranged at the outer end part of the telescopic tube 241. When the telescopic rod 241 is stretched, the limiting pin is limited on the limiting hole. The outer end part of the telescopic rod 241 is vertically provided with a connecting shaft; the connecting shaft is sleeved with a handle sleeve 243; and the handle sleeve 243 can rotate freely on the connecting shaft.

### Embodiment 2

Embodiment 2 and embodiment 1 have basically the same features, but the differences are that: the lower end of the liner 10 is provided with a first joint 102; the first joint 102 is detachably provided with a positioning cup 14; a capsule box 19 for placing capsules is installed in the positioning cup 14; the coffee cup 11 is installed at the outer side of the positioning cup 14; the bottom of the positioning cup 14 is provided with a capsule bottom cover net 20; a plurality of bumps 201 and through holes 202 are rectangularly arrayed on the capsule bottom cover net 20; the bumps 201 are square bumps; and the sharp ends of the square bumps can puncture the capsules. A water passage is formed between the adjacent bumps 201; the through holes 202 are arranged at the intersection of two water passages; a capsule box 19 is inverted on the capsule bottom cover net 20; a water through hole 191 communicated with the water hole 1211 is arranged at the top of the capsule box 19; a blade 192 for piercing the capsules is installed at the top of the inner cavity of the capsule box 19 near the water through hole 191; the blade 192 is an annular cutter and is installed around the water through hole 191; a plurality of sharp sheets are uniformly distributed on the blade 192; the blade 192 is used for piercing the capsules, so that hot water enters a pierced capsule, and the hot water in the lower cavity body flows into the capsule box 19 through the water through hole 191. Under the action of water pressure, the lower end of the capsule is pierced by the sharp corners of the bumps 201, and the coffee flows to a coffee outlet 141 through the water through hole 191.

### Embodiment 3

Embodiment 3 and embodiment 1 or 2 have basically the same features, but the differences are that: the coffee cup 11 is clamped and connected with the first joint 102; a plurality of positioning parts 21 are uniformly distributed on the outer side wall of the upper end of the first joint 102; and the positioning parts 21 are integrally formed on the first joint 102. In the present embodiment, the number of the positioning parts 21 is three. A plurality of clamping parts 111 are uniformly distributed on an inner wall of the coffee cup 11 near a cup opening; the clamping parts 111 are integrally formed on the coffee cup 11; the number of the clamping parts 111 is the same as the number of the positioning parts 21 and the clamping parts 111 and the positioning parts 21 are in one-to-one correspondence; and the clamping parts 111 of the coffee cup 11 are clamped, positioned and connected with the positioning parts 21 of the positioning cup 14.

Each positioning part 21 comprises a first positioning block 211, a second positioning block 212 and a clamping block 213; the first positioning block 211 and the second positioning block 212 are arranged in parallel; a positioning slot 210 is formed between the first positioning block 211 and the second positioning block 212; the clamping block 213 is installed in the positioning slot 210; each clamping part 111 is a third positioning block; the third positioning block is provided with a clamping slot 112; and when the coffee cup 11 is clamped and connected with the positioning cup 14, the clamping part 111 is limited in the positioning slot 210, and the clamping block 213 is clamped in the clamping slot 112. The clamping part 111 on the coffee cup is limited in the positioning slot 210 of the positioning part 21, and the clamping slot 112 on the clamping part is also clamped and connected with the clamping block 213, so that the coffee cup has high stability on the first joint 102.

A plurality of positioning parts 21 are also arranged on the outer side wall of the lower end of the positioning cup 14; the number of the positioning parts 21 at the lower end of the positioning cup 14 is also three, and the positioning parts are uniformly distributed on the positioning cup 14. When coffee is made by the coffee cup 11, the coffee cup 11 is clamped and connected with the positioning parts 21 at the lower end of the positioning cup 14. When people need to make coffee, only the coffee cup 11 is clamped on the positioning parts 21 on the positioning cup 14, which is convenient to operate.

### Embodiment 4

Embodiment 4 and embodiment 1 have basically the same features, but the differences are that: the driving rod 13 is a polished rod; the screw rod-screw thread adapter 23 is arranged in the middle of the water injection cover 22; and the driving rod 13 is pulled or compressed to drive the piston assembly 12 to rise or fall.

1. A manual coffee machine, comprising a liner (10), a coffee cup (11), a piston assembly (12) and a driving rod (13), wherein the driving rod (13) is connected with the piston assembly (12) and drives the piston assembly to rise and fall in the liner (10); the piston assembly (12) separates an inner cavity of the liner (10) into an upper cavity body (101) and a lower cavity body; the piston assembly (12) comprises a piston (121), a bracket (122) and a valve core (123); the piston (121) is provided with a water hole (1211) through which water flows from the upper cavity body (101) into the lower cavity body; the valve core (123) is limited and installed between the bracket (122) and the water hole (1211) through the bracket (122); when the piston assembly (12) rises and falls, the valve core (123) unblocks or blocks the water hole (1211); wherein a pressure relief channel (1230) for communicating the upper cavity body (101) and the lower cavity body is arranged in the valve core (123); a port which communicates the pressure relief channel (1230) and the lower cavity body is a pressure relief port (12301); a spring (1233) and a sealing body (1234) are installed in the pressure relief channel (1230); and the spring (1233) is pressed against the sealing body (1234) on the pressure relief port (12301).

2. The manual coffee machine according to claim 1, wherein the bracket (122) is an integral bracket; the bracket (122) comprises a limiting segment (1221) and supporting segments (1222); a projection shape of the limiting segment (1221) is annular; the driving rod (13) is firmly connected with the valve core (123) through the limiting segment (1221); at least two supporting segments (1222) are uniformly distributed around the limiting segment (1221); pistons (121) at lower ends of the supporting segments (1222) are firmly connected; and when the water hole (1211) is partitioned, a gap (120) is arranged between a top end of the valve core (123) and the limiting segment (1221).

3. The manual coffee machine according to claim 1, wherein the valve core (123) comprises a valve core body (1231) and a valve core cover (1232); the valve core cover (1232) is in threaded connection with the valve core body (1231); the valve core cover (1232) is connected with the driving rod (13) by screws; the pressure relief channel (1230) comprises a spring cavity (12302) and a pressure relief hole (12303); the spring cavity (12302) is arranged between the valve core body (1231) and the valve core cover (1232); the spring (1233) is installed in the spring cavity (12302); the pressure relief hole (12303) is arranged in a side wall of the valve core body (1231); the pressure relief hole (12303) is communicated with the upper cavity body (101) and the spring cavity (12302); a lower end of the spring cavity (12302) is funnel-shaped; the sealing body (1234) is a sealing sphere; and the sealing body (1234) is limited on a conical surface of the spring cavity (12302).

4. The manual coffee machine according to claim 1, wherein a lower end of the liner (10) is provided with a first joint (102); the first joint (102) is detachably provided with a positioning cup (14); a bottom of the positioning cup (14) is provided with a funnel-shaped coffee outlet (141); a powder bin box (15) is installed in the positioning cup (14); the coffee cup (11) is installed at an outer side of the positioning cup (14); a powder bin cover (16) arranged below the water hole (1211) is installed at a top end of the powder bin box (15); the powder bin cover (16) is provided with a plurality of water diversion holes (161) communicated with the powder bin box (15); and a silicone flat valve (17) for extruding coffee liquid is installed at a bottom of the powder bin box (15).

5. The manual coffee machine according to claim 1, wherein the lower end of the liner (10) is provided with a first joint (102); the first joint (102) is detachably provided with a positioning cup (14); a capsule box (19) for placing capsules is installed in the positioning cup (14); the coffee cup (11) is installed at the outer side of the positioning cup (14); the bottom of the positioning cup (14) is provided with a capsule bottom cover net (20); a plurality of bumps (201) and through holes (202) are arrayed on the capsule bottom cover net (20); the capsule box (19) is inverted on the capsule bottom cover net (20); the top of the capsule box (19) is provided with a water through hole (191) communicated with the water hole (1211); and a blade (192) for piercing a capsule is installed at the top of the inner cavity of the capsule box (19) near the water through hole (191).

6. The manual coffee machine according to claim 5, wherein the coffee cup (11) is clamped and connected with the first joint (102); a plurality of positioning parts (21) are uniformly distributed on the outer side wall of the upper end of the first joint (102); a plurality of clamping parts (111) are uniformly distributed on an inner wall of the coffee cup (11) near a cup opening; and the clamping parts (111) of the coffee cup (11) are clamped, positioned and connected with the positioning parts (21) of the positioning cup (14).

7. The manual coffee machine according to claim 6, wherein each positioning part (21) comprises a first positioning block (211), a second positioning block (212) and a clamping block (213); the first positioning block (211) and the second positioning block (212) are arranged in parallel; a positioning slot (210) is formed between the first positioning block (211) and the second positioning block (212); the clamping block (213) is installed in the positioning slot (210); each clamping part (111) is a third positioning block; the third positioning block is provided with a clamping slot (112); and when the coffee cup (11) is clamped and connected with the positioning cup (14), the clamping part (111) is limited in the positioning slot (210), and the clamping block (213) is clamped in the clamping slot (112).

8. The manual coffee machine according to claim 1, wherein the top end of the liner (10) is provided with a water injection cover (22); a water injection hole (221) communicated with the upper cavity body (101) is arranged on the water injection cover (22); a screw rod-screw thread adapter (23) is arranged in the middle of the water injection cover (22); the driving rod (13) is a screw rod; the screw rod extends from the water injection cover through the screw rod-screw thread adapter (23); and the top end of the driving rod (13) is provided with a telescopic handle (24).
